(19) United States
(12) Patent Application Publication
(10) Pub. No.: US 2010/0304006 A1
(43) Pub. Date: Dec. 2, 2010

(54) METHOD OF MANUFACTURING SILICA-COATED METAL NANOPARTICLES

(75) Inventors: Fabien Delpech, Nailloux (FR); Celine Nayral, Toulouse (FR); Nancy El hawi, Toulouse (FR)

Correspondence Address: YOUNG & THOMPSON, 209 Madison Street, Suite 500, Alexandria, VA, 22314, US

(73) Assignees: INSTITUT NATIONAL DES SCIENCES APPLIQUEES DE TOULOUSE (I.N.S.A.T.), Toulouse (FR); UNIVERSITE PAUL SABATIER (U.P.S.), Toulouse Cedex 9 (FR); CENTRE NATIONAL DELA RECHERCHE SCIENTIFIQUE (C.N.R.S.), Paris (FR)

(21) Appl. No.: 12/743,406

(22) PCT Filed: Nov. 18, 2008
(86) PCT No.: PCT/FR2008/052076

§ 371 Date: Aug. 18, 2010

(30) Foreign Application Priority Data
Nov. 19, 2007 (FR) 07.08107

(51) Int. Cl. B05D 5/00

(52) U.S. Cl. 427/2.14

(57) ABSTRACT

A method of producing silica-coated metal nanoparticles with at least one tetraalkoxysilane, from nanoparticles, referred to as metal nanoparticles, includes a quantity of at least one metal of zero oxidation state, a quantity of a catalytic hydrolysis composition, a quantity of liquid solvent medium and a quantity of water, so as to obtain a hydrolysis/condensation enabling the metal nanoparticles to be coated with silica, wherein the liquid solvent medium consists of at least one solvent chosen from the group formed by non-alcoholic organic solvents.

The invention relates to a method of manufacturing silica-coated metal nanoparticles.

Silica-coated metal nanoparticles are useful in particular in the biomedical field, and more particularly in therapeutic applications involving a localized hyperthermia treatment, and in the field of information technology and microelectronics. The coating of metal nanoparticles allows the metallic core of the nanoparticles to be isolated electrically or chemically. In the biomedical field, this silica coating also allows organic targeting ligands to be grafted on to the surface of the nanoparticles. In particular, silica-coated metal nanoparticles can be distributed in the organism to their therapeutic target via the systemic route and contribute towards the development of novel therapeutic techniques. For example, they allow a local increase in temperature at the level of the target by application of a magnetic field. They thus allow, by local hyperthermia, an increase in the sensitivity of cells or tissues to a drug also delivered by the systemic route.

Various methods of producing silica-coated metal nanoparticles are already known. Kobayashi Y. et al., (2003), J. Phys. Chem. B, 107, 7420-7425 describes a method of the sol/gel hydrolysis/condensation type for coating cobalt nanoparticles in a mixed polar solvent containing 200 ml of water and 800 ml of ethanol in the presence of tetraethyl orthosilicate (TEOS) and 3-aminopropyl-trimethoxysilane. However, such a method does not allow metal nanoparticles of significant magnetization to be obtained.

Fernandez-Pacheco R. et al. (2006), Nanotechnology, 17, 1188-1192 describes a method of producing silica-coated metal nanoparticles by sublimation of powdered silica (SiO₂) in an electric arc and in an air void. The silica sublimed in this way is then condensed around the metal particles. Such a method assumes the use of a device which generates an electric discharge and a device which establishes and maintains a vacuum in the reaction chamber. Such methods are complex and difficult to implement on an industrial scale. Furthermore, this method does not allow silica-coated metal nanoparticles having optimum magnetic properties, and in particular silica-coated metal nanoparticles substantially free from oxidized metal derivatives to be obtained.

The object of the invention is therefore to remedy these disadvantages by proposing a method of manufacturing silica-coated metal nanoparticles, in particular metal nanoparticles based on a metal or alloy of metals, referred to as oxidizable, the said method allowing the magnetic properties of the initial metal nanoparticles to be preserved in the course of the production of the said silica-coated metal nanoparticles.

The object of the invention in particular is to propose a method which allows the production of silica-coated metal nanoparticles having magnetic properties suitable for their use in the therapeutic and electronic fields.

The object of the invention is also to propose a method which allows the production of silica-coated metal nanoparticles based on an oxidizable metal or alloy of oxidizable metals from metal particles of nanometre size, that is to say having a high surface/volume ratio.

The object of the invention is also to propose a method of producing silica-coated metal nanoparticles for in vivo therapeutic applications, said particles being not recognized and neutralized by the immune system and eliminated by the reticulo-endothelial system.

The object of the invention is also to propose a method of producing silica-coated metal nanoparticles which subsequently allow chemical grafting of targeting motifs—in particular antibodies—on to the accessible surface of the silica.

The object of the invention is also to propose a method of producing silica-coated metal nanoparticles, the said method being compatible with a prior method of producing substantially non-oxidized metal nanoparticles.

The object of the invention is also to propose a method of manufacturing silica-coated metal nanoparticles, the magnetic properties of which are substantially equivalent to the magnetic properties of the metallic material of which they are made (metal or alloy of metals) when its oxidation state is zero.

In addition, the object of the invention is to propose a method of manufacturing silica-coated metal nanoparticles which is simple, easy to carry out, does not use a complex device for pumping and maintaining a vacuum and can be carried out in a single container with a single solvent by simple addition of synthesis reagents which are readily commercially accessible.

The object of the invention is also to propose a method of producing silica-coated metal nanoparticles which is compatible with the use of starting nanoparticles produced beforehand in an organic, non-alcoholic, non-oxidizing solvent.

The object of the invention is also to achieve all of these objects at a reduced cost by proposing a method of producing silica-coated metal nanoparticles of low cost price carried out by conventional inexpensive chemical means.

In the following, the term “nanoparticle” designates a particle the shape of which is a sphere, the average diameter of the said sphere being between 2 nm and 100 nm.

The invention thus relates to a method of producing silica-coated metal nanoparticles by means of at least one tetraalkoxysilane, from nanoparticles, referred to as metal nanoparticles, comprising a quantity of at least one metal of zero oxidation state, a quantity of a catalytic hydrolysis composition, a quantity of liquid solvent medium and a quantity of water, so as to obtain a hydrolysis/condensation enabling the metal nanoparticles to be coated with silica, wherein
the liquid solvent medium consists of at least one solvent chosen from the group formed by non-alcoholic organic solvents,
the reaction conditions are chosen such that the silica-coated metal nanoparticles obtained have a magnetization and such that the difference between the magnetization value (at saturation) of the silica-coated metal nanoparticles obtained and the magnetization value (at saturation) of the starting metal nanoparticles is less than 15%.

The inventors have found that the use of a liquid solvent medium consisting of at least one non-alcoholic and consequently non-aqueous organic solvent allows the quantity of water present in the reaction medium to be limited to that strictly necessary for the hydrolysis/condensation reaction. Oxidation of the metal nanoparticles prior to the reaction of coating with silica is thus avoided. As a result, if the other reaction conditions are chosen appropriately (to avoid direct contact between the water and the metal surface of the nanoparticles before coating), the use of such a liquid solvent medium allows the production of silica-coated metal nanoparticles which are substantially free from oxidized metal and which have a difference between the magnetization value of the silica-coated metal nanoparticles and the magnetization value of the starting metal nanoparticles of less than 15% of the magnetization value of the starting metal nanoparticles. In particular, the said difference is between 0.5% and 5%. The magnetic properties of the silica-coated metal nanoparticles are, in particular, substantially indistinguishable from the magnetic properties of the starting metal nanoparticles, within the uncertainty of the measurement of the magnetization value.

The use of such a liquid solvent medium also allows the production of silica-coated metal nanoparticles which can be used directly in suspension in the said liquid solvent medium for subsequent stages of modification by a chemical route, especially subsequent stages of chemical modification of the outer surface of the said metal nanoparticles, and in particular subsequent stages of grafting of recognition motifs on to the outer surface of the said metal nanoparticles.

The inventors have also found that the use of a liquid solvent medium consisting of at least one solvent chosen from the group formed by non-alcoholic organic solvents allows the solubilization of tetraalkoxysilane(s), of the hydrolysis catalyst and of the water and also allows suspension of the metal nanoparticles.

Thus, advantageously and according to the invention, the hydrolysis/condensation reaction of the tetraalkoxysilane(s) is carried out in a manner such that oxidation of the metal nanoparticles by direct contact of the said quantity of water with the outer surface of the said metal nanoparticles is prevented. For this purpose, numerous variants of carrying out the reaction are possible. In a first variant, the reaction is carried out in two successive stages, the first of which allows hydrolysis and substantial reduction of the quantity of water in the absence of the metal nanoparticles. In a second variant, a composition of hydroprotective additives suitable for formation of a protective coating around the nanoparticles which is capable of limiting or preventing the said direct oxidation of the metal nanoparticles is used. These two variants can be combined, and other variants allowing the initial magnetic properties of the metal nanoparticles to be preserved are possible.

Thus, in a first variant, the invention therefore relates to a method of producing silica-coated metal nanoparticles by means of at least one tetraalkoxysilane, from nanoparticles, referred to as metal nanoparticles, comprising a quantity of at least one metal of zero oxidation state, a quantity of a catalytic hydrolysis composition, a quantity of liquid solvent medium and a quantity of water, so as to obtain a hydrolysis/condensation enabling the metal nanoparticles to be coated with silica, wherein
the liquid solvent medium consists of at least one solvent chosen from the group formed by non-alcoholic organic solvents,
in a first stage a solution, referred to as the hydrolysis solution, containing a quantity of water, a quantity of tetraalkoxysilane(s), the catalytic hydrolysis composition and a quantity of the liquid solvent medium is produced, and then in a subsequent stage the said hydrolysis solution is added to a suspension containing the metal nanoparticles in suspension in a quantity of liquid solvent medium.

The inventors have thus found that carrying out the hydrolysis/condensation reaction in two successive stages, the first stage leading to hydrolysis of the tetraalkoxysilane, in a non-alcoholic organic solvent in the presence of a catalytic hydrolysis composition and of a quantity of water, that is to say carrying out the said hydrolysis of the tetraalkoxysilane in the absence of metal nanoparticles, allows oxidation of the said metal nanoparticles to be lessened.

Thus, carrying out the hydrolysis/condensation reaction in two stages comprising a first stage of hydrolysis of the tetraalkoxysilane(s) in the presence of a quantity of water and a quantity of a liquid solvent medium in the presence of a catalytic hydrolysis composition allows a solution containing a quantity of reactive silanol derivatives but also substantially free from water to be obtained at the end of this hydrolysis stage and after a sufficiently long reaction time. The contact of the said solution containing the said reactive silanol derivatives with the metal nanoparticles thus does not lead to oxidation of the said metal nanoparticles, which keep their magnetic properties.

The use of a catalytic hydrolysis composition in the course of the first stage of the hydrolysis/condensation reaction allows the time necessary for hydrolysis of the tetraalkoxysilane(s) into the silanol derivative during the first stage of the reaction to be substantially reduced. The rapid and substantially complete hydrolysis of the tetraalkoxysilane(s) during the first stage thus allows condensation of the silanol derivatives with one another to be avoided, in particular in the course of the first stage of the reaction, and also allows mixing of the preparation containing an effective quantity of silanol with the suspension of metal nanoparticles for coating of the metal nanoparticles.

In this first variant, a method according to the invention is thus carried out by dissociating the stage of hydrolysis and therefore of consumption of the initial quantity of water introduced and the stage of condensation of silanol derivatives on to the metal nanoparticles, which allows oxidation of the metal nanoparticles by direct contact of the said quantity of water with the said metal nanoparticles to be prevented.

In a method according to the first variant of the invention, the molar ratio of the quantity of water/the quantity of the tetraalkoxysilane(s) is advantageously less than 3, in particular equal to 2. The inventors have found that, surprisingly, such a molar ratio is sufficient to allow effective coating of the metal nanoparticles, but also sufficiently low to allow substantial reduction, after a sufficiently long time, of the quantity of free water in the reaction medium in the course of the first phase of hydrolysis of the hydrolysis/condensation reaction. This substantial reduction in the quantity of free water in the reaction medium allows, in particular, the magnetic properties of the silica-coated metal nanoparticles to be preserved.

Still more surprisingly, the inventors have found that in spite of an initial quantity of water of less than the stoichiometric quantity for hydrolysis of each alkoxysilane substituent of the tetraalkoxysilane(s), the subsequent polycondensation reaction of silanol derivatives with the metal nanoparticles and of the silanol derivatives with each other in a non-alcoholic liquid solvent medium is very effective. A possible explanation of this surprising result would be that the polycondensation reaction would generate in situ, by dehydration, a sufficient additional quantity of water capable of allowing additional hydrolysis of alkoxysilane substituents of the tetraalkoxysilane(s) into silanol derivatives.

This production of an additional quantity of water in situ would allow hydrolysis of alkoxysilane substituents of the tetraalkoxysilane(s) into silanol without, however, leading to oxidation of the metallic material (metal or alloy of metals) making up the metal nanoparticles.

In a method according to the first variant of the invention, an initial molar quantity of water Qe such that the ratio

$$Ns = {\sum }_{i}^{n} 4 \times \frac{{m}_{i}}{{M}_{i}} \times \frac{{RA}_{i}}{Rm} , \qquad ( 1 )$$

with:

$${τ}_{1} = \frac{Qe}{Ns} ,$$

where: in, is the quantity by weight of the metal i of the metal nanoparticles,

RAᵢ is the atomic radius of the metal i,

Rm is the average radius of the metal nanoparticles,

Mᵢ is the molar mass of the metal i,

n is the number of metallic chemical elements which make up the nanoparticles,

is less than 20, in particular between 5 and 16, especially substantially close to 13, is advantageously used.

The number Ns is a number indicating the number of metal sites of zero oxidation state accessible on the surface of the metal nanoparticles allowing variations in the surface, depending on the size of the metal nanoparticles, to be taken into consideration, all things otherwise being equal.

The inventors have thus found that such a ratio τ₁ of less than 20, in particular between 5 and 16, especially substantially close to 13, allows silica-coated metal nanoparticles which are of high quality and have magnetic properties comparable to the magnetic properties of the initial non-coated metal nanoparticles to be obtained.

The conditions for obtaining silica-coated metal nanoparticles having preserved magnetic properties depend, in fact, on the proportion of metal of zero oxidation state effectively accessible to the water and thus on the specific surface area and thus on the size of the metal nanoparticles.

In a second variant, the invention relates to a method of producing silica-coated metal nanoparticles by means of at least one tetraalkoxysilane, from nanoparticles, referred to as metal nanoparticles, comprising a quantity of at least one metal of zero oxidation state, a quantity of a catalytic hydrolysis composition, a quantity of liquid solvent medium and a quantity of water, so as to obtain a hydrolysis/condensation enabling the metal nanoparticles to be coated with silica, wherein

the liquid solvent medium consists of at least one solvent chosen from the group formed by non-alcoholic organic solvents,

the metal nanoparticles, a quantity of liquid solvent medium, the catalytic hydrolysis composition, a composition, referred to as a composition of hydroprotective additives, comprising at least one compound, referred to as a hydroprotective compound are mixed,
said protective compound being adapted to form, by grafting on to a surface metal atom, a chemical function —O-A, A being a chemical element other than hydrogen,
the said chemical function being stable in the presence of water, but reactive to grafting of silica,
the kinetics of grafting of the said hydroprotective compound on to a metal atom of zero oxidation state being faster than the kinetics of oxidation of the said metal atom of zero oxidation state by water,
   and a quantity of tetraalkoxysilane(s) and the said quantity of water are then added to this mixture.

The inventors have thus found that carrying out the hydrolysis/condensation reaction in a single stage of hydrolysis and condensation in a solvent medium consisting of at least one non-alcoholic organic solvent in the presence of metal nanoparticles, of a catalytic hydrolysis composition and of a composition of hydroprotective additives, and adding the quantity of water and the quantity of tetraalkoxysilane(s) to this reaction medium produced beforehand allows oxidation of the said metal nanoparticles by the initial water to be avoided. In particular, the metal nanoparticles obtained have magnetic properties which are substantially identical to those of the starting metal nanoparticles.

Although no clear explanation can be given for this surprising result, the inventors think that such a composition of hydroprotective additives allows the formation of sacrificial metal oxide on the surface of the metal nanoparticles, preventing oxidation of the metal nanoparticles by direct contact with water, and not substantially modifying the magnetic properties of the metal nanoparticles obtained.

Under the conditions for carrying out a method according to the second variant of the invention, the rate of reaction of the grafting of the hydroprotective compounds on to the metal nanoparticles is in fact greater than the rate of reaction of the oxidation of the surface of the metal nanoparticles by water.

Furthermore, under these same conditions, the rate of reaction of the oxidation of the surface of the metal nanoparticles by water is of the same order of size as the rate of reaction of the grafting of the tetraalkoxysilane on to the surface of the metal nanoparticles.

As a result, when carrying out a method according to the second variant of the invention, simultaneous mixing of the liquid solvent medium chosen from the group formed by organic non-alcoholic solvents, of the metal nanoparticles, of the catalytic hydrolysis composition and of the composition of hydroprotective additives chiefly and rapidly leads to the formation of a bond between the hydroprotective compound and the metal, thus forming the protective sacrificial oxide on the surface of the metal nanoparticles, and preventing oxidation of the metal nanoparticles by the free water present in the reaction medium.

The hydroprotective compounds are compounds which are capable of formation, by grafting on to surface metal atoms (of the metal nanoparticles) of zero oxidation state, a chemical function —O-A, where A is a chemical element other than hydrogen. The hydroprotective compounds according to the invention cannot form, by grafting on to the surface metal atoms, chemical functions —OH which are capable of modifying the magnetic properties of the nanoparticles.

The chemical function —O-A is stable in the presence of water, that is to say it is not split in the presence of water and protects the metal of the metal nanoparticles from oxidation by water.

The chemical function —O-A is reactive to grafting of silica in that it allows covalent bonds to be subsequently established with the silica of the coating of the metal nanoparticles.

Thus, in this second variant of a method according to the invention a very partial and perfectly controlled oxidation of a limited thickness of the metal nanoparticles by a composition of hydroprotective additives is thus carried out, the said limited thickness of the oxidized metal preventing direct contact of the said initial quantity of water with the said metal nanoparticles, thus protecting the main part of the core of the metal nanoparticles which remains non-oxidized from oxidation.

In a method according to the second variant of the invention, an initial molar quantity of water Qe such that the ratio

$${τ}_{1} = \frac{Qe}{Ns} ,$$

Ns being given by formula (1) above, is less than 120, in particular between 30 and 50, especially close to 39, is advantageously used.

Such a value of the ratio τ₁ surprisingly allows oxidation of the metal nanoparticles to be prevented.

Advantageously and according to the invention, at least one hydroprotective compound is chosen such that A belongs to the group formed from boron, aluminium, lead, calcium, magnesium, barium, sodium, potassium, iron, zinc, manganese, silicon and phosphorus.

In particular, the use of such a hydroprotective compound allows the formation of oxide, referred to as sacrificial oxide, with the metal sites of the surface of the metal nanoparticles, preventing direct contact of water with these metal sites. In particular, the kinetics of the formation of this sacrificial oxide are faster than the kinetics of the oxidation of the metal nanoparticles by water.

In addition, such a protective compound allows the metal nanoparticles to be protected from oxidation by water, but also allows introduction of atomic elements which are capable of modulating the functional properties of the silica-coated metal nanoparticles into the layer of silica formed by hydrolysis/condensation of the tetraalkoxysilane. In fact, the hydroprotective compounds which are capable of formation, by grafting on to a surface metal atom (of the metal nanoparticles) of zero oxidation state, a chemical function —O-A, where A is a chemical element other than hydrogen, are additionally and advantageously capable of formation of a similar chemical function —O-A by grafting on to the silica.

In a method according to the second variant of the invention, at least one hydroprotective compound is advantageously chosen from the group formed by:
elements A,
compounds containing at least one function of the formula R-A-, R being chosen from the group formed by aliphatic hydrocarbon substituents, benzyls, tolyls, phenyls and methoxyphenyls,
compounds containing at least one function of the formula R—O-A-, R being chosen from the group formed by aliphatic hydrocarbon substituents, benzyls, tolyls, phenyls and methoxyphenyls and
compounds containing at least one hydroxyl function of the formula HO-A-.

In a method according to the second variant of the invention a molar quantity of hydroprotective compounds Qch such that the ratio

$${τ}_{2} = \frac{Qch}{Ns} ,$$

Ns being given by formula (1) above, is between 1/10 and 10, especially between 1/10 and 3, in particular of the order of 1, is advantageously used.

In a method according to the second variant of the invention, phosphoric acid is advantageously used as the hydroprotective compound. Thus, advantageously and according to the invention, the said composition of hydroprotective additives is a composition of phosphoric acid. The inventors have found that the addition of a quantity of phosphoric acid as the hydroprotective compound in a reaction medium according to the second variant of the invention allows silica-coated metal nanoparticles to be obtained which have a magnetization and in which the difference between the magnetization value of the silica-coated metal nanoparticles obtained and the magnetization value of the starting metal nanoparticles is less than 15%.

In a method according to the invention (in the two abovementioned variants), extraction of the gases of the liquid solvent medium, of the tetraalkoxysilane(s), of the catalytic hydrolysis composition and of the water is advantageously carried out prior to bringing the said liquid solvent medium, the tetraalkoxysilane(s), the catalytic hydrolysis composition and the water into contact with the metal nanoparticles.

The inventors have found that extraction of the gases—especially the dissolved oxygen—of the liquid media—especially the liquid solvent medium, the water and the tetraalkoxysilane—introduced into the reaction medium allows, in particular, metal nanoparticles in which the magnetic properties are preserved to be obtained.

In particular, extraction of the gases can be achieved by reducing the pressure of the air inside the container containing the liquids to be degassed (extraction of gases), and then by returning the container to atmospheric pressure by introducing an inert gas into it. For example, the gases are eliminated in particular by reducing the pressure inside the container containing the liquids to be degassed (extraction of gases), the said liquids to be degassed being in a solid frozen form.

In a method according to the invention (in the two abovementioned variants), the metal nanoparticles advantageously contain at least one metal chosen from the group formed by metals having a standard oxido-reduction potential of less than 0 V, in particular between −0.5 V and −0.2 V.

Advantageously and according to the invention, the metal nanoparticles contain at least one metal chosen from the group formed by iron, cobalt, nickel and manganese. In particular, the metal nanoparticles contain at least one metal alloy formed from magnetic metals having a standard oxido-reduction potential of between −0.5 V and −0.2 V, in particular iron, cobalt, nickel and manganese. This is the case for the metal nanoparticles of the alloy Fe/Co described in the examples. However, nothing prevents the use of metal nanoparticles containing a metal alloy of at least one magnetic metal having a standard oxido-reduction potential of between −0.5 V and −0.2 V, in particular iron, cobalt, nickel and manganese, and an element chosen from the group formed by boron, carbon, aluminium, silicon, phosphorus, sulfur, titanium, vanadium, chromium, manganese, copper, gallium, germanium, zirconium, niobium, molybdenum, rhodium, palladium, indium, tin, antimony, praseodymium, neodymium, tungsten, platinum and bismuth. However, the proportion of such a metal in the metal alloy of which the metal nanoparticles are made is chosen to allow the magnetic properties of the metal having a standard oxido-reduction potential of between −0.5 V and −0.2 V to be substantially preserved in the metal alloy formed.

Advantageously and according to the invention, the tetraalkoxysilane(s) has/have the general formula Si(OR₁)(OR₂)(OR₃)(OR₄), where R₁, R₂, R₃, R₄ are chosen from the group formed by aliphatic hydrocarbon groupings.

Advantageously and according to the invention, the tetraalkoxysilane(s) has/have a number of carbon atoms of less than 17. In fact, the inventors have found that tetraalkoxysilanes having a number of carbon atoms of less than 17 have a sufficiently high rate of the hydrolysis reaction to allow the production of silica-coated metal nanoparticles in which the magnetic properties are preserved with respect to the starting metal nanoparticles. In addition, they have found that tetraalkoxysilanes having a number of carbon atoms of less than 17 have, under the operating conditions of the invention, a rate of the hydrolysis reaction greater than the rate of the oxidation of the metal nanoparticles by water. In a method according to the invention, the initial quantity of water thus allows hydrolysis of tetraalkoxysilane(s) having a number of carbon atoms of less than 17 without significantly degrading the magnetic properties of the silica-coated metal nanoparticles.

Advantageously and according to the invention, the tetraalkoxysilane(s) is/are chosen from the group formed by tetramethoxysilane and tetraethoxysilane.

Advantageously and according to the invention, the liquid solvent medium comprises at least one solvent chosen from the group formed by polar aprotic solvents, in particular ketone solvents and ether solvents.

Advantageously and according to the invention, the liquid solvent medium comprises at least one solvent chosen from the group formed by tetrahydrofuran and dimethyl ether. In a method according to the invention, a liquid solvent medium which is perfectly miscible with the said initial quantity of water such that the mixture of the said initial quantity of water in the liquid solvent medium forms a true solution is advantageously chosen.

Advantageously and according to the invention, the reaction is carried out in a hermetically closed container and under an inert gas atmosphere, the said inert gas being chosen from the group formed by argon, helium and nitrogen.

Advantageously and according to the invention, the said catalytic hydrolysis composition comprises at least one amine, in particular a primary aliphatic amine

Advantageously and according to the invention, the said catalytic hydrolysis composition comprises at least one amine chosen from the group formed by butylamine, octylamine, dodecylamine and hexadecylamine.

Advantageously and according to the invention, the metal nanoparticles are produced in a quantity of the said liquid solvent medium.

The invention also relates to silica-coated metal nanoparticles obtained by a method according to the invention, wherein the silica-coated metal nanoparticles have an atomic proportion of less than 15% of metal, referred to as oxidized metal, the oxidation state of which is greater than 0.

The invention also relates to a method of manufacturing silica-coated metal nanoparticles, which has a combination of all or some of the characteristics mentioned above or below.

Other objects, characteristics and advantages of the invention will emerge from reading the following description, which refers to the attached figures showing preferred embodiments of the invention given merely by way of non-limiting examples, and in which.

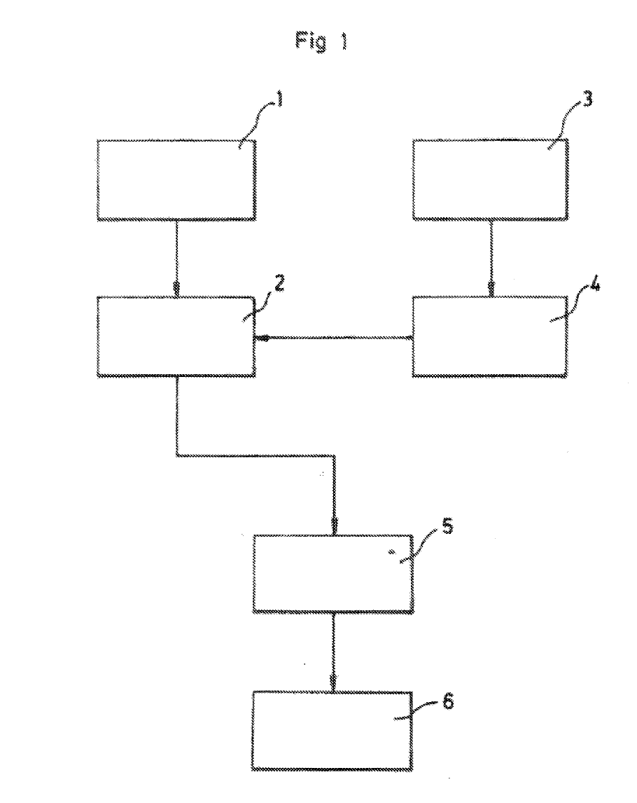

FIG. 1 is a synoptic synthesis diagram illustrating one of the variants of the method according to the invention,

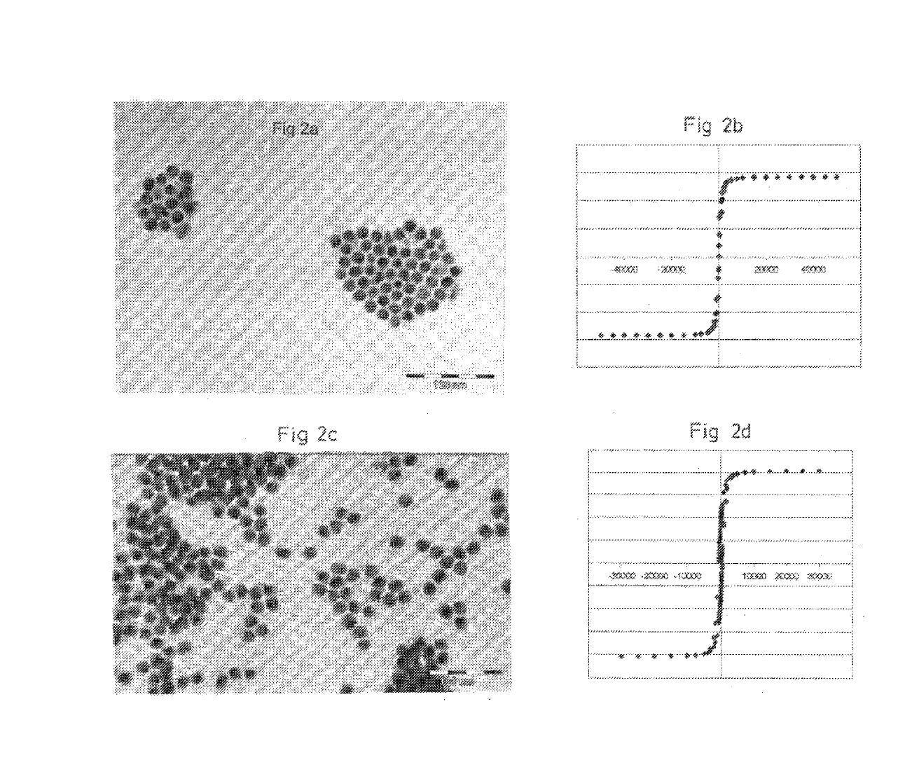

FIGS. 2a and 2c are electron microscopy photographs of metal nanoparticles, and FIGS. 2b and 2d are magnetization curves of metal nanoparticles characterizing a method according to the first variant of the invention.

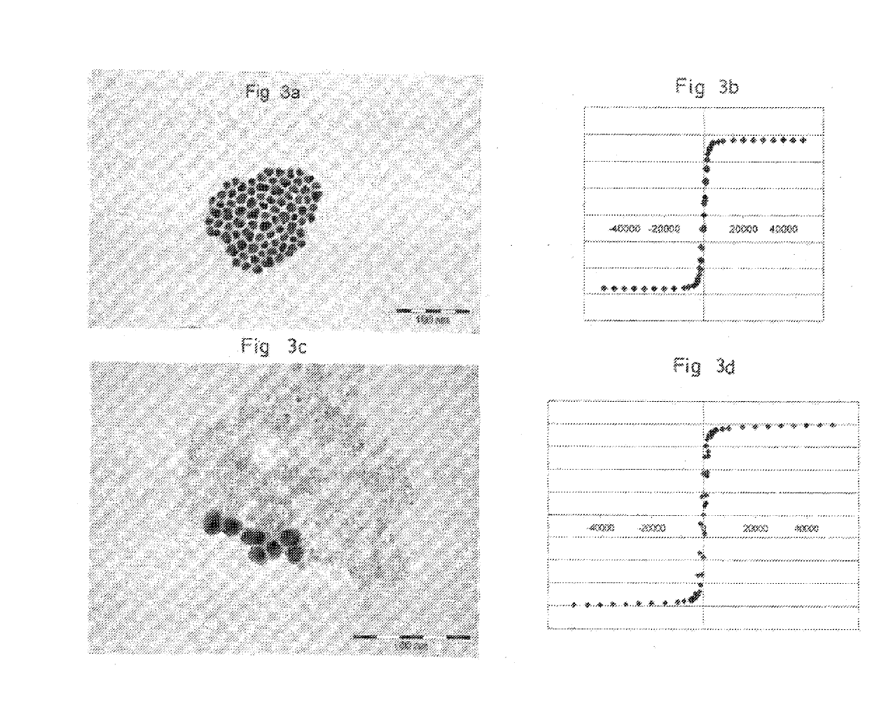

FIGS. 3a and 3c are electron microscopy photographs of metal nanoparticles, and FIGS. 3b and 3d are magnetization curves of metal nanoparticles characterizing a method according to the second variant of the invention.

### EXAMPLE 1

### Reaction in One Stage

Metal nanoparticles of the alloy Fe/Co are produced beforehand in accordance with the method described in US 2005/0200438. In practice, 282.45 mg of oleic acid and 241 mg of hexadecylamine (Fluka, Saint-Quentin-Fallavier, France) are dissolved in 50 ml of freshly distilled mesitylene by mechanical stirring and the solution is degas sed by freezing/extraction in vacuo for 20 min. The solution of oleic acid in mesitylene is added to a container of the Fischer-Porter reactor type containing 276 mg of cobalt precursor (Co(COD)₂, Nanomeps, Toulouse, France) and 270 μl of iron precursor (Fe(CO)₅, Aldrich, Saint-Quentin-Fallavier, France), and the reaction medium is heated at a temperature of 150° C. under a pressure of 3,000 hPa for 48 h.

The magnetization of the metal nanoparticles is measured by means of a SQUID magnetometer at 25° C., before coating, and the shape and size of the metal nanoparticles are observed by transmission electron microscopy (TEM). The magnetization curve is shown in FIG. 2b and the TEM photograph obtained is shown in FIG. 2a. The magnetization value at saturation of the metal nanoparticles in suspension in tetrahydrofuran (THF, SDS, Peypin, France) before coating, calculated from the magnetic saturation curve (FIG. 2b) and elemental analyses, is 130 electromagnetic units per gram of nanoparticles (emu/g). The size distribution of the metal nanoparticles is homogeneous and the average size is 14.3 nm.

20 mg of nanoparticles of the alloy Fe/Co as produced above and containing 4 mg of organic ligand (hexadecylamine and oleic acid), 7.6 mg of iron and 8.4 mg of cobalt, as well as 4 ml of THF freshly purified by distillation and degassed and 65 mg of hexadecylamine are introduced into a gas-tight glass reactor, in particular a Schlenk tube, under an inert atmosphere of argon. After homogenization, 2.65 mg of phosphoric acid (H₃PO₄, Aldrich, Saint-Quentin-Fallavier, France) dissolved in 1 ml of THF are added to the reactor while maintaining the inert atmosphere.

60 μl of tetraethoxysilane (TEOS, Alfa-Aesar, Karlsruhe, Germany) and 14 μl of degassed water mixed in 3 ml of THF distilled and degassed beforehand are then added to the reactor under an inert atmosphere. The mixture is left for 170 h, while stirring. Under these conditions, the molar ratio between the Fe/Co alloy, the TEOS, the hexadecylamine and the water is 1/1/1/3. Furthermore, the molar ratio between the Fe/Co alloy and the phosphoric acid is 10.

The magnetization of the metal nanoparticles is measured at 25° C. after the reaction and the shape and size of the silica-coated nanoparticles are observed by transmission electron microscopy (TEM). The magnetization curve is shown in FIG. 2d and the TEM photograph obtained is shown in FIG. 2c. The magnetization value at saturation of the metal nanoparticles in suspension in THF before coating, calculated from the magnetic saturation curve (FIG. 2d) and elemental analyses, is 130 emu/g of metal nanoparticles, which is a value equivalent to that of the non-coated metal nanoparticles. The average diameter of the silica-coated metal nanoparticles is 17.9 nm, which is substantially greater than the diameter of the starting metal nanoparticles. In this example, the value of τ₁ is 39 and the value of τ₂ is 1.4.

### EXAMPLE 2

### Reaction in Two Stages

A suspension 1 is produced in a gas-tight glass reactor, in particular a Schlenk tube, as shown in FIG. 1. For this, 20 mg of nanoparticles of the alloy Fe/Co, produced beforehand in accordance with the method described above in Example 1, and described in US 2005/0200438, and containing 4 mg of organic ligand (hexadecylamine and oleic acid), 7.6 mg of iron and 8.4 mg of cobalt, as well as 4 ml of freshly distilled and degassed THF and 6.8 μl of butylamine (Aldrich, Saint-Quentin-Fallavier, France) are introduced. A homogeneous suspension 2 is obtained by mechanical stirring.

The magnetization of the metal nanoparticles is measured by means of a SQUID magnetometer at 25° C., before coating, and the shape and size of the metal nanoparticles used in the example are observed by transmission electron microscopy (TEM). The magnetization curve is shown in FIG. 3b and the TEM photograph obtained is shown in FIG. 3a. The magnetization value at saturation of the metal nanoparticles in suspension in THF before coating, calculated from the magnetic saturation curve (FIG. 3b) and elemental analyses, is 180 electromagnetic units per gram of nanoparticles (emu/g). The average diameter of the metal nanoparticles is 14.3 nm.

The solution 3 is produced in a glass ampoule compatible with a gas-tight intake of the glass reactor (Schlenk tube) by mixing 2 ml of THF degassed by freezing/extraction in vacuo with 30 μl of TEOS and 4.86 μl of water degassed by freezing/extraction in vacuo in a molar ratio of water/TEOS equal to 2 under an argon atmosphere. After mechanical stirring (vortex type) at a temperature of 25° C. for one hour, solution 4 is obtained. Solution 4 is added to the glass reactor containing the degassed suspension 2 of metal nanoparticles in THF, while still under an inert atmosphere. Under these conditions, the molar ratio of the Fe/Co alloy, the TEOS, the butylamine and the water in the reaction mixture is 2/1/0.5/2. The reaction mixture 5 is left at 25° C. for about 170 h, while stiffing. The final product 6 is obtained.

The magnetization of the silica-coated metal nanoparticles obtained in this way in the medium 6 is measured at 25° C. and the shape and size of the said metal nanoparticles are observed by transmission electron microscopy (TEM). The magnetization curve is shown in FIG. 3d and the TEM photograph obtained is shown in FIG. 3c. The magnetization value at saturation of the metal nanoparticles in suspension in THF before coating, calculated from the magnetic saturation curve (FIG. 3d) and elemental analyses, is 179 emu/g of metal nanoparticles, which is a value substantially equivalent to that of the non-coated metal nanoparticles. The average diameter of the silica-coated metal nanoparticles is 17.2 nm, which is substantially greater than the average diameter of the metal nanoparticles before coating. In this example, the value of τ₁ is 13.

### COMPARATIVE EXAMPLE 3

### Reaction in One Stage, without Addition of Phosphoric Acid

The magnetization of metal nanoparticles obtained by a method as described above is measured at 25° C. The magnetization value at saturation of such metal nanoparticles in suspension in THF is 179 emu/g of metal nanoparticles.

20 mg of nanoparticles of the alloy Fe/Co as produced above and containing 4 mg of organic ligand (hexadecylamine and oleic acid), 7.6 mg of iron and 8.4 mg of cobalt, as well as 4 ml of THF freshly purified by distillation and 6.5 mg of hexadecylamine are introduced into a gas-tight glass reactor, in particular a Schlenk tube, under an inert atmosphere of argon. The suspension is homogenized by mechanical stirring for 1 h.

60 μl of TEOS and 14 μl of degassed water in 2 ml of THF distilled and degassed beforehand are then added to the reactor under an inert atmosphere. The mixture is left for 170 h, while stirring.

Under these conditions, the molar ratio between the Fe/Co alloy, the TEOS, the hexadecylamine and the water is 1/1/1/3, in particular identical to the ratio chosen in Example 1, but without phosphoric acid.

After coating, the magnetization of the silica-coated metal nanoparticles obtained in this way is measured at 25° C. The magnetization value at saturation of the metal nanoparticles in suspension in THF after the coating procedure is 67 emu/g of metal nanoparticles, a value which is very distinctly less (62%) than the magnetization value before the coating treatment.

These examples consequently demonstrate that the method of producing silica-coated metal nanoparticles according to the present invention allows silica-coated metal nanoparticles to be obtained which have a high quality and have not only magnetic properties which are preserved with respect to the initial metal nanoparticles, but also magnetic properties which are compatible with their industrial therapeutic and electronic applications.

1/ A method of producing silica-coated metal nanoparticles by means of at least one tetraalkoxysilane, from nanoparticles, referred to as metal nanoparticles, comprising a quantity of at least one metal of zero oxidation state, a quantity of a catalytic hydrolysis composition, a quantity of liquid solvent medium and a quantity of water, so as to obtain a hydrolysis/condensation enabling the metal nanoparticles to be coated with silica, wherein the liquid solvent medium consists of at least one solvent chosen from the group formed by non-alcoholic organic solvents.

2/ The method as claimed in claim 1, wherein in a first stage a solution, referred to as the hydrolysis solution, containing an initial quantity of water, a quantity of tetraalkoxysilane(s), the catalytic hydrolysis composition and a quantity of the liquid solvent medium is produced, and then in a subsequent stage the said hydrolysis solution is added to a suspension containing the metal nanoparticles in suspension in a quantity of liquid solvent medium.

3/ The method as claimed in claim 1, wherein the molar ratio of water/tetraalkoxysilane(s) is less than 3, in particular equal to 2.

4/ The method as claimed in claim 1, wherein an initial molar quantity of water Qe such that the ratio
$${τ}_{1} = \frac{Qe}{Ns} ,$$
with:
$$Ns = {\sum }_{i}^{n} 4 \times \frac{{m}_{i}}{{M}_{i}} \times \frac{{RA}_{i}}{Rm} , \qquad ( 1 )$$
where: mᵢ is the quantity by weight of the metal i of the metal nanoparticles,
RAᵢ is the atomic radius of the metal i,
Rm is the average radius of the metal nanoparticles,
Mᵢ is the molar mass of the metal i,
n is the number of metallic chemical elements which make up the nanoparticles,
is less than 20, in particular between 5 and 16, especially substantially close to 13, is used.

5/ The method as claimed in claim 1, wherein the metal nanoparticles, a quantity of liquid solvent medium, the catalytic hydrolysis composition, a composition, referred to as a composition of hydroprotective additives, comprising at least one compound, referred to as a hydroprotective compound are mixed,
said protective compound being adapted to form, by grafting on to a surface metal atom, a chemical function —O-A, A being a chemical element other than hydrogen,
the said chemical function being stable in the presence of water, but reactive to grafting of silica,
the kinetics of grafting of the said hydroprotective compound on to a metal atom of zero oxidation state being faster than the kinetics of oxidation of the said metal atom of zero oxidation state by water,
and a quantity of tetraalkoxysilane(s) and the said quantity of water are then added to this mixture.

6/ The method as claimed in claim 5, wherein an initial molar quantity of water Qe such that the ratio
$${τ}_{1} = \frac{Qe}{Ns} ,$$
with:
$$Ns = {\sum }_{i}^{n} 4 \times \frac{{m}_{i}}{{M}_{i}} \times \frac{{RA}_{i}}{Rm} , \qquad ( 1 )$$
where: mᵢ is the quantity by weight of the metal i of the metal nanoparticles,
RAᵢ is the atomic radius of the metal i,
Rm is the average radius of the metal nanoparticles,
Mᵢ is the molar mass of the metal i,
n is the number of metallic chemical elements which make up the nanoparticles,
is less than 120, in particular between 30 and 50, especially close to 39, is used.

7/ The method as claimed in claim 5, wherein at least one hydroprotective compound is chosen such that A belongs to the group formed from boron, aluminium, lead, calcium, magnesium, barium, sodium, potassium, iron, zinc, manganese, silicon and phosphorus.

8/ The method as claimed in claim 5, wherein at least one hydroprotective compound is chosen from the group formed by:
elements A,
compounds containing at least one function of the formula R-A-, R being chosen from the group formed by aliphatic hydrocarbon substituents, benzyls, tolyls, phenyls and methoxyphenyls,
compounds containing at least one function of the formula R—O-A-, where R is chosen from the group formed by aliphatic hydrocarbon substituents, benzyls, tolyls, phenyls and methoxyphenyls,
compounds containing at least one hydroxyl function of the formula HO-A-.

9/ The method as claimed in claim 5, wherein a molar quantity of hydroprotective compounds Qch such that the ratio
$${τ}_{2} = \frac{Qch}{Ns} ,$$
Ns being given by the formula (1) above, is between 1/10 and 10, especially between 1/10 and 3, in particular of the order of 1, is used.

10/ The method as claimed in claim 5, wherein phosphoric acid is used as the hydroprotective compound.

11/ The method as claimed in claim 1, wherein an extraction of the gases of the liquid solvent medium, of the tetraalkoxysilane(s), of the catalytic hydrolysis composition and of the water is carried out prior to bringing the said liquid solvent medium, the tetraalkoxysilane(s), the catalytic hydrolysis composition and the water into contact with the metal nanoparticles.

12/ The method as claimed in claim 1, wherein the metal nanoparticles contain at least one metal chosen from the group formed by metals having a standard oxido-reduction potential of less than 0 V, in particular between −0.5 V and −0.2 V.

13/ The method as claimed in claim 1, wherein the metal nanoparticles contain at least one metal chosen from the group formed by iron, cobalt, nickel and manganese.

14/ The method as claimed in claim 1, wherein the tetraalkoxysilane(s) has/have the general formula Si(OR₁)(OR₂)(OR₃)(OR₄), where R₁, R₂, R₃, R₄ are chosen from the group formed by aliphatic hydrocarbon groupings.

15/ The method as claimed in claim 1, wherein the tetraalkoxysilane(s) has/have a number of carbon atoms of less than 17.

16/ The method as claimed in claim 1, wherein the tetraalkoxysilane(s) is/are chosen from the group formed by tetramethoxysilane and tetraethoxysilane.

17/ The method as claimed in claim 1, wherein the liquid solvent medium comprises at least one solvent chosen from the group formed by polar aprotic solvents, in particular ketone solvents and ether solvents.

18/ The method as claimed in claim 1, wherein the liquid solvent medium comprises at least one solvent chosen from the group formed by tetrahydrofuran and dimethoxy ether.

19/ The method as claimed in claim 1, wherein the reaction is carried out in a hermetically closed container and under an inert gas atmosphere, the said inert gas being chosen from the group formed by argon, helium and nitrogen.

20/ The method as claimed in claim 1, wherein the said catalytic hydrolysis composition comprises at least one amine, in particular a primary aliphatic amine.

21/ The method as claimed in claim 1, wherein the said catalytic hydrolysis composition comprises at least one amine chosen from the group formed by butylamine, octylamine, dodecylamine and hexadecylamine.

22/ The method as claimed in claim 1, wherein the metal nanoparticles are produced beforehand in a quantity of the said liquid solvent medium.

23/ The method as claimed in claim 1, wherein the reaction conditions are chosen such that the silica-coated metal nanoparticles obtained have a magnetization and such that the difference between the magnetization value of the silica-coated metal nanoparticles obtained and the magnetization value of the starting metal nanoparticles is less than 15%.
